(19) United States
(12) Patent Application Publication
(10) Pub. No.: US 2003/0065638 A1
(43) Pub. Date: Apr. 3, 2003

(54) The method to comstomize the appearance of a wab page by dragging and dropping objects within a web page

(76) Inventor: Jason Robert, Carrollton, TX (US)

Correspondence Address: Jason Dornback, 2116 Sonata Lane, Carrollton, TX, 75007, US

(21) Appl. No.: 09/955,449

(22) Filed: Sep. 19, 2001

(51) Int. Cl. G06F 7/00

(52) U.S. Cl. 707/1

(57) ABSTRACT

Method of customizing the appearance of a web page by dragging and dropping objects from one location on the web page to a new location. This method enables the content of web pages to be easily customized by users. The dragged object can be any portion of the HTML web page (text, hyperlinks, forms, images, tables, or other HTML components). The object is immediately displayed in the new location. The new location of the object can be (a) saved temporarily for the current user, (b) saved permanently for the current user, or (c) saved for all users that view that web page.

### FIELD OF THE INVENTION

The present invention relates generally web pages, and more particularly to an innovative method and system for allowing users to rearrange the content of a web page by dragging and dropping objects within the web page, and having that object remain in the new location for some period of time. The new location of the objects can be saved temporarily or permanently for the current user, or saved for all users of that web page. This invention enables user of the web page to easily and extensively customize the page.

### BACKGROUND OF THE INVENTION

The Internet is a worldwide system of computer networks—a network of networks in which users at any one computer can, if is has permission, get information from any other computer. Intranets are similar services that are available on private local area networks (LANs). The World Wide Web (WWW) and similar private architectures provide a “web” of interconnected documents, called “web pages” on intranets and the internet.

Web pages are typically made up of HyperText Markup Language (HTML) tags displaying HTML source files containing the headings, data, text, footings and hyperlinks to other web pages. An HTML document includes a hierarchical set of markup elements; most elements have a start tag, followed by content, followed by an end tag. The content is a combination of text and nested markup tags. HTML tags, which are enclosed in angle brackets (‘<’ and ‘>’), indicate how the document is structured and how to display the document, as well as destinations and labels for hypertext links. There are tags for markup elements such as titles and headers, text attributes such as bold, italic, lists, paragraph boundaries, links to other documents or other parts of the same document, in-line graphic images, and for many other features. Javascript provides a way to include programs, which are downloaded in a Web page, enabling the user to change some page properties. More information about javascript and the Java programming language may be found in Java in a Nutshell by David Flanagan, published by O'Reilly & Associates .COPYRGT.1996.

Web server software languages such as Active Server Pages (ASP), Java Server Pages (JSP), or ColdFusion are software languages that are executed on the web server. They provide a method for determining what content to serve to the client computer. These languages also provide interfaces to the web server resources, such as files or databases stored on the server. Such software languages also provide methods of sending, retrieving, and processing information sent to and from web pages.

### SUMMARY OF THE INVENTION

Defined objects on a web page may be dragged and dropped to different locations on the web page with the mouse. The dragged object can be any portion of the HTML web page (text, hyperlinks, forms, images, tables, or other HTML content).

The object is displayed while it is being dragged, and is immediately displayed in the new location when dropped. The new location of the object can be saved so that next time the web page is viewed, the object is displayed in the new location. The object is able to be moved (or dragged) by the user to a new location anywhere on the web page. The new location of the object may be (a) saved temporarily for the current user, (b) saved permanently for the current user, or (c) saved for all users that view that web page.

A draggable object on a web page may be any HTML content on the page. Images can be dragged directly with this method, if the image is not hyperlinked to another location. Non-images and images with hyperlinks currently require a small target image that the mouse can “grab” to drag the entire object.

### BRIEF DESCRIPTION OF THE DRAWINGS

FIG. 1 is a view of the web page prior to user moving objects.

FIG. 2 is a view of the same web page after user has moved objects.

FIG. 3 is a flowchart that illustrates the logical steps for the implementation of dragging and dropping an object on a web page.

FIG. 4 is sample javascript for the mouse down event.

FIG. 5 is sample javascript for the mouse move event.

FIG. 6 is sample javascript for the mouse up event.

FIG. 7 is sample javascript to catch the mousedown, mousemove, and mouseup events.

FIG. 8 is sample Active Server Pages code for a Snap-To-Grid.

FIG. 9 is sample Active Server Pages code to track the location of 5 objects, and save the location of the objects as cookies.

FIG. 10 is sample HTML/Active Server Pages code for a draggable object.

FIG. 11 is sample Active Server Pages code to track the location of 6 objects on a web page, and save the location of the objects on the server.

FIG. 12 is the entire Demo4.asp sample file.

### DETAILED DESCRIPTION OF THE INVENTION

The present invention enables a user to drag and drop defined objects on a web page to a different location on the web page, The new location of the object may be (a) saved temporarily for the current user, (b) saved permanently for the current user, or (c) saved for all users that view that web page. An object may be any combination of HTML code displayed to the user such as, formatted text, forms, hyperlinks, tables, or images. An object is defined with the HTML <div>tag.

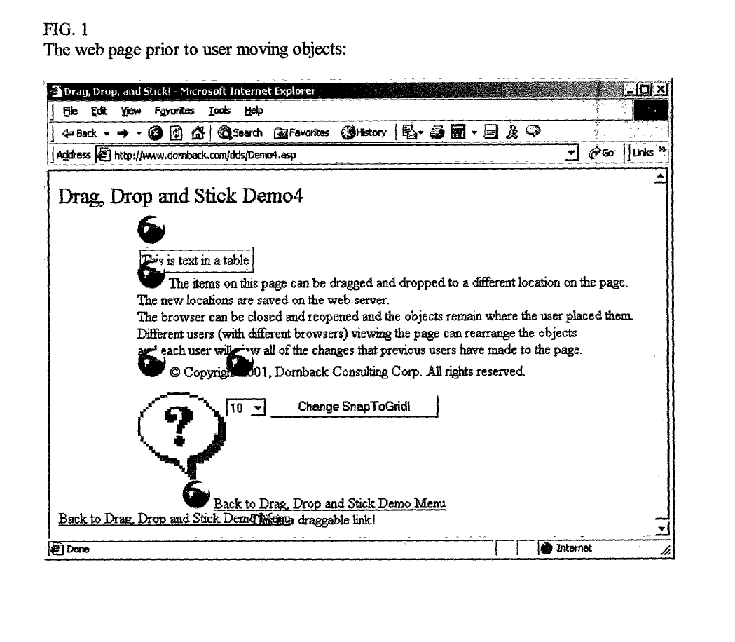

FIG. 1 shows the sample web page “Demo4.asp” as it is displayed when initially loaded in a web browser. There are multiple objects on the page that may be dragged and dropped to new locations by the user. An image may be dragged directly with the mouse with this invention. The large image of the question mark in FIG. 1 can be dragged and dropped directly with the mouse. Some HTML code cannot currently be dragged directly with the mouse due to the current leimtations of HTML and javascript. Some HTML code requires interaction with the mouse, such as hyperlinked images. Because of this, some objects on the web page require a target image that can be dragged. The target images in FIG. 1 are displayed as circular images at the top left of each object. When the target inage is dragged, all of the HTML code defined within that object is dragged. Future implementations of HTML and javascript may allow these objects to be dragged directly without requiring a target image.

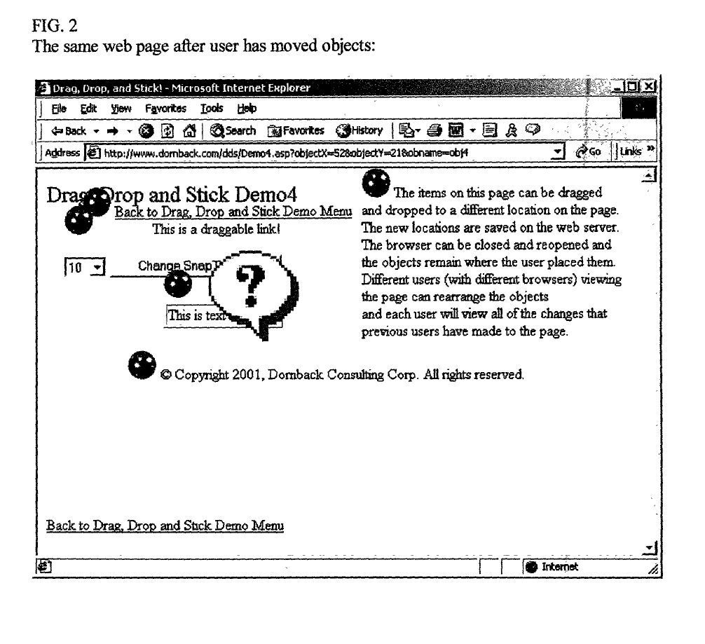

FIG. 2 displays the same web page after the user has dragged and dropped several objects to new locations on the web page with the mouse. Note that the objects may overlap before or after the user moves them. Also note that the objects may contain HTML code that interacts with the mouse, such as hyperlinks or forms.

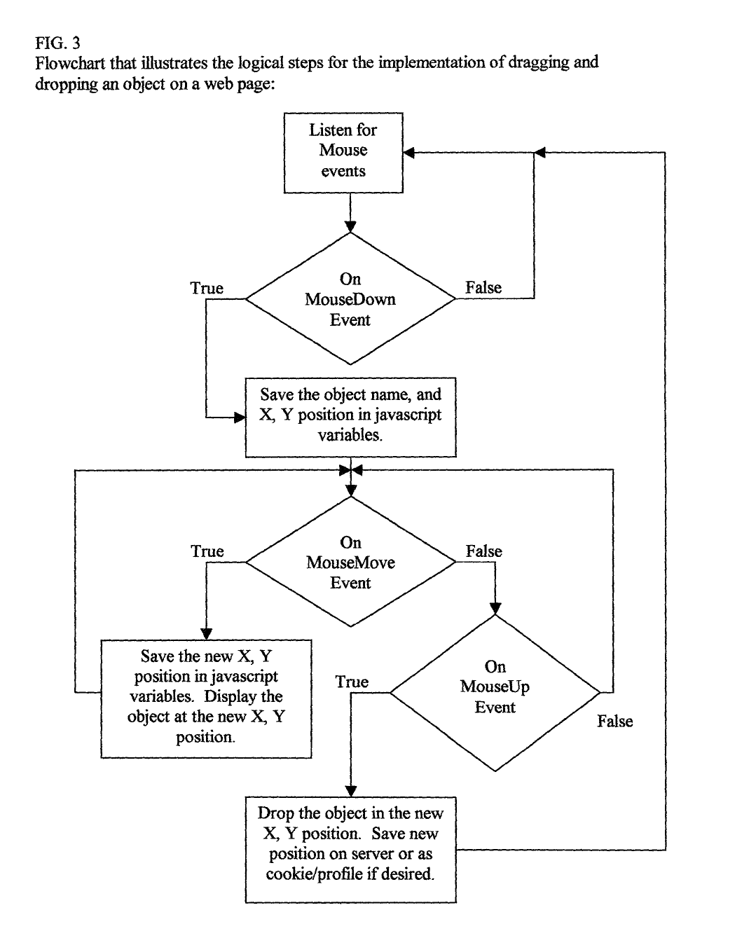

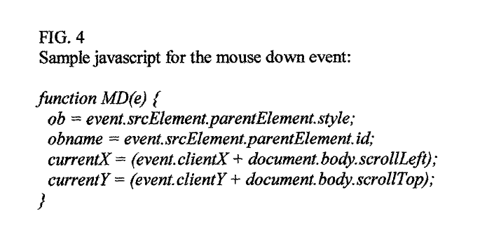

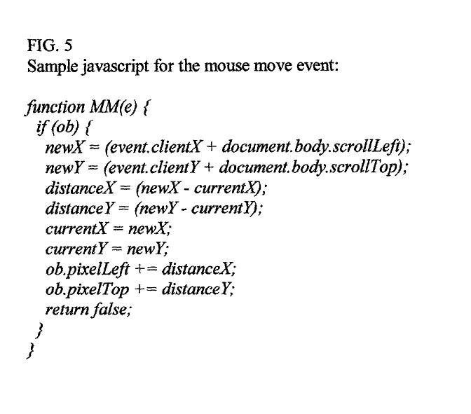

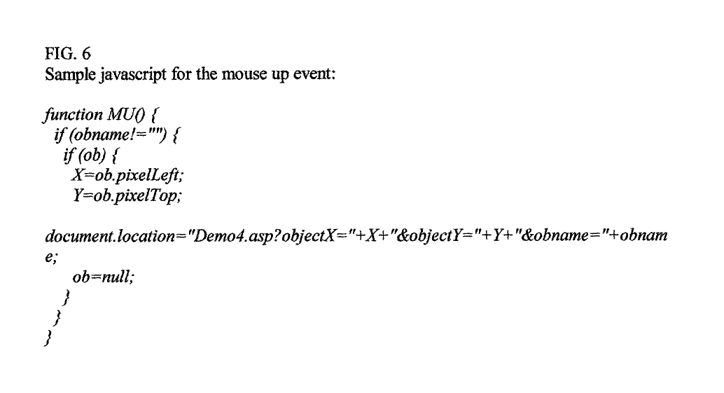

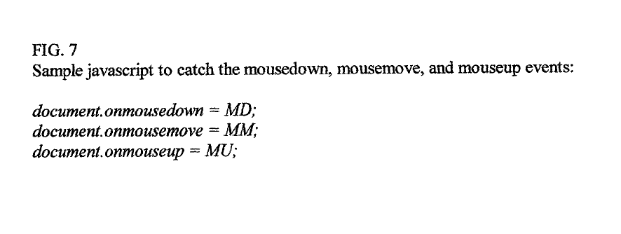

The dragging and dropping of the objects within the web page is accomplished by tracking the mouse events with javascript. FIG. 3 shows the general flow of the javascript mouse event functions. Javascript is used to listen for the MouseDown, MouseMove, and MouseUp events, as shown in FIG. 7. When any of those mouse events occur, specific javascript functions are executed. The javascript functions for the MouseDown, MouseMove, and MouseUp events are shown in FIG. 4, FIG. 5, and FIG. 6. The javascript functions for the mouse events specifically check for objects that are defined as movable on the page. This approach ensures that the functions are only executed for objects that are defined as draggable with the <div>tag, and other HTML code such as hyperlinks or forms that also utilize the mouse, still function properly for the user.

After the object is dragged and dropped by the user, the new location of the object is either:

(a) Saved temporarily for the current user. Only the current user sees the new locations of the objects. The objects only remain in the new locations for that user until the web page is reloaded (or refreshed). The objects will revert to their original location if the web page is re-opened or refreshed.

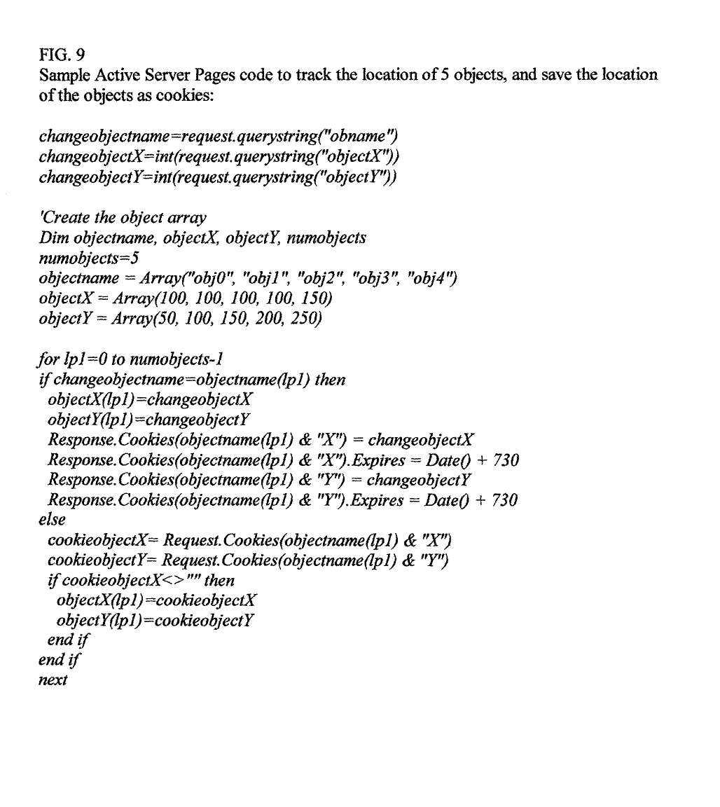

(b) Saved only for that user. The changes made to the location of the objects on the page are displayed only the user that made the change. Only the user that moved the objects will see the objects in the new locations. The objects will remain in the new locations for that user even if the page is reloaded (or refreshed). Different users are able to arrange the objects differently; each user only sees his/her own changes, not the changes of other users. The object location can be saved in a user profile with web browser cookies. If the new object location is saved as a cookie, then only the user of that web browser will see the new location, and each user of the web site can independently change the location of the same object. This allows different users of the same web page to customize the view of the page by rearranging objects on the page. FIG. 9 shows sample Active Server Pages code to save the location of the objects as cookies in the users browser.

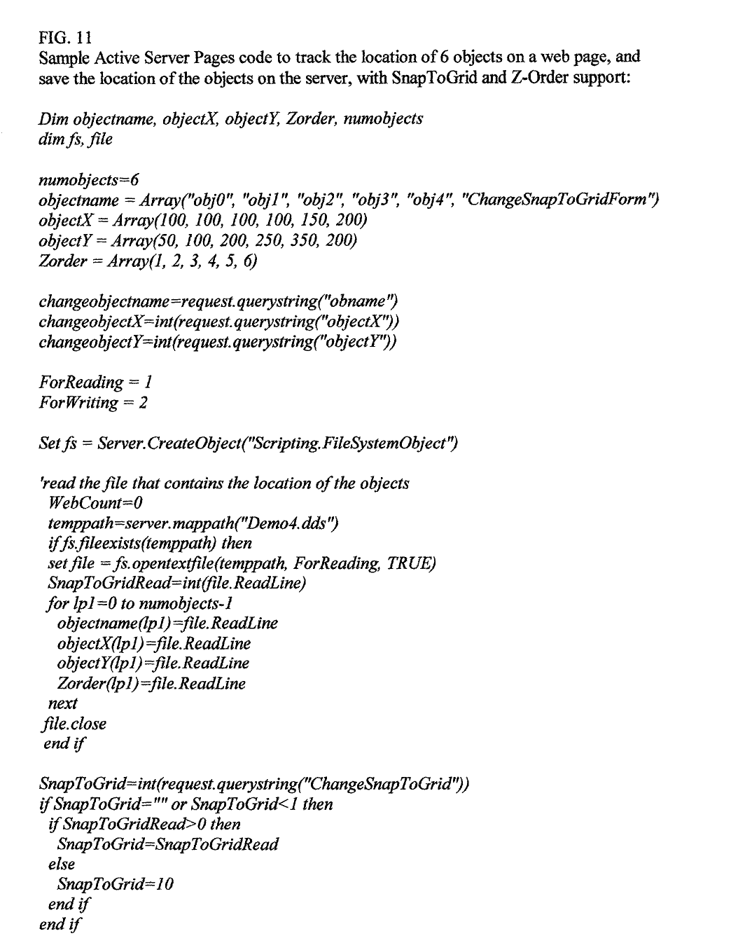

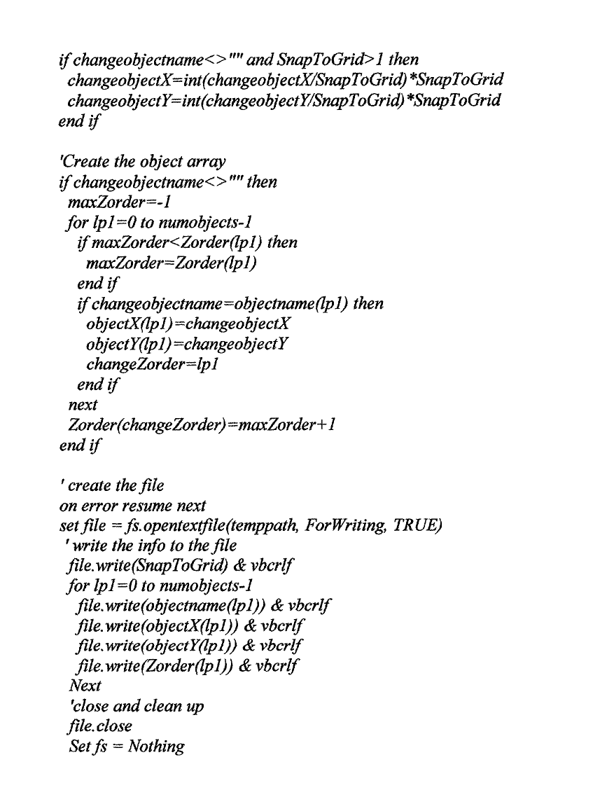

(c) Saved for all users that view that web page. The changes made to the location of the objects on the page are displayed to all users that view the web page. The object location can be saved in a database or file on the server. FIG. 11 shows sample Active Server Pages code to save the location of the objects as a file on the web server.

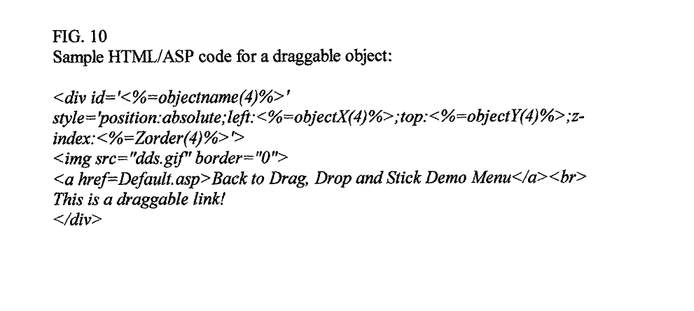

FIG. 10 shows HTML sample code for a moveable object. The HTML <div> tag is used to define the object. All of the HTML code between the begining <div> tag and the ending </div> tag is draggable with the mouse in this invention. The HTML code within the <div> tags could contain formatted text, images, tables, forms, or other HTML code. An HTML form could include any of the available form elements such as buttons, text boxes, drop down lists, or check boxes.

Since the draggable object in FIG. 10 is text, the <div> tag must be include a target image that the mouse can grab to drag the text: <img src=“dds.gif” border=“0”> This image included in the <div> tag allows the user to grab that image and drag the entire content of the <div> tag. Note that the target image must be contained within the <div> tag, and also must not be contained within a table or form. Images within the <div> tag that are within a table or form are not recognized as draggable objects in the current versions of HTML and javascript.

The object name, X location, and Y location of the object is specified within the <div> tag. The HTML <div> tag may also include tags that define other attributes of the object, such as background color, height, and width. The layering order of the objects (commonly known as z-order) defines what object is displayed on top if the objects overlap. The z-order can be easily defined within each object by changing the “z-index” tag in the <div> tag. Objects with higher z-index values are displayed on top of objects with lower z-index values if the objects overlap. This allows certain objects to always remain on top if the objects overlap. Note that the z-order does not currently work for certain HTML elements, such as form dropdown lists, which always remain on top. This is a limitation of current HTML and javascript code.

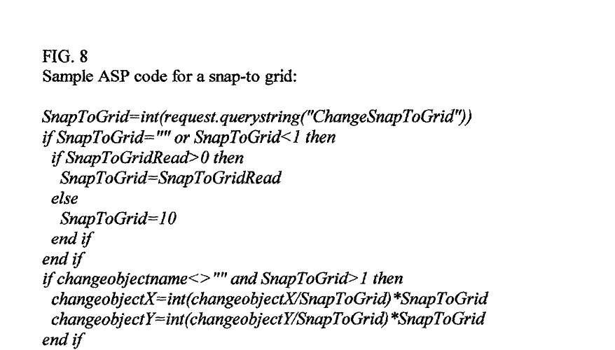

A Snap-To-Grid can be implemented to assist the user with lining up objects on the web page after they are moved. If the Snap-To-Grid is used, the location of dropped objects will be changes slightly to line up with the closest grid coordinates. If the Snap-To-Grid is not implemented, the objects will be placed exactly where the user drops them. A SnapToGrid value of 1 pixel is the equivalent of turning the grid off. Sample code for implementing a Snap-To-Grid is displayed in FIG. 8. The “SnapToGrid” grid variable determines how close together the grid coordinates are located.

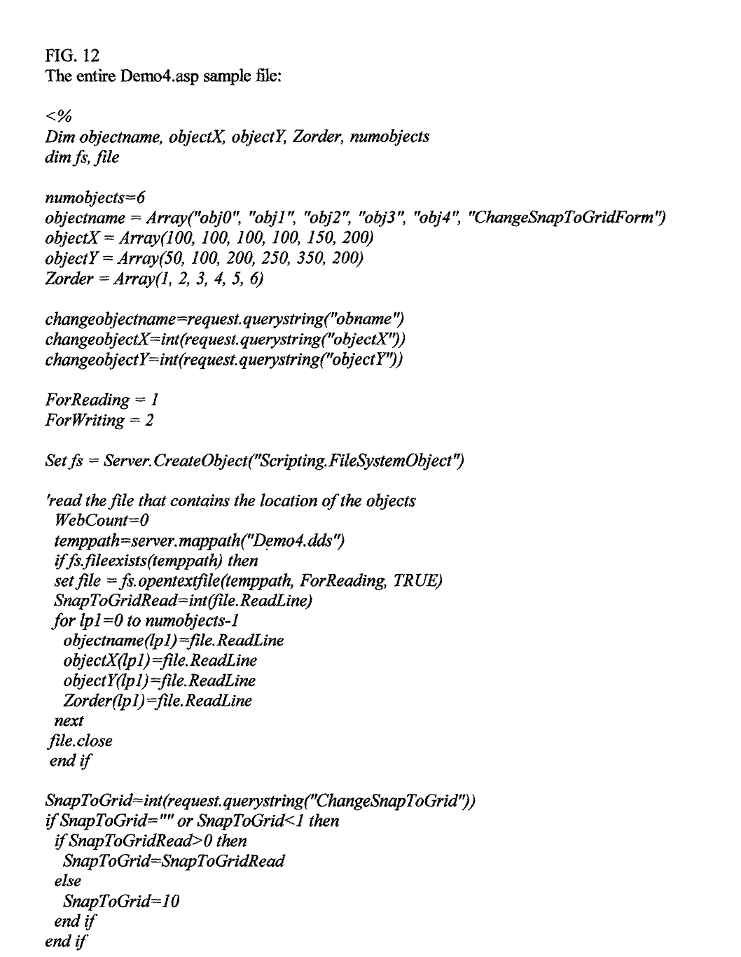

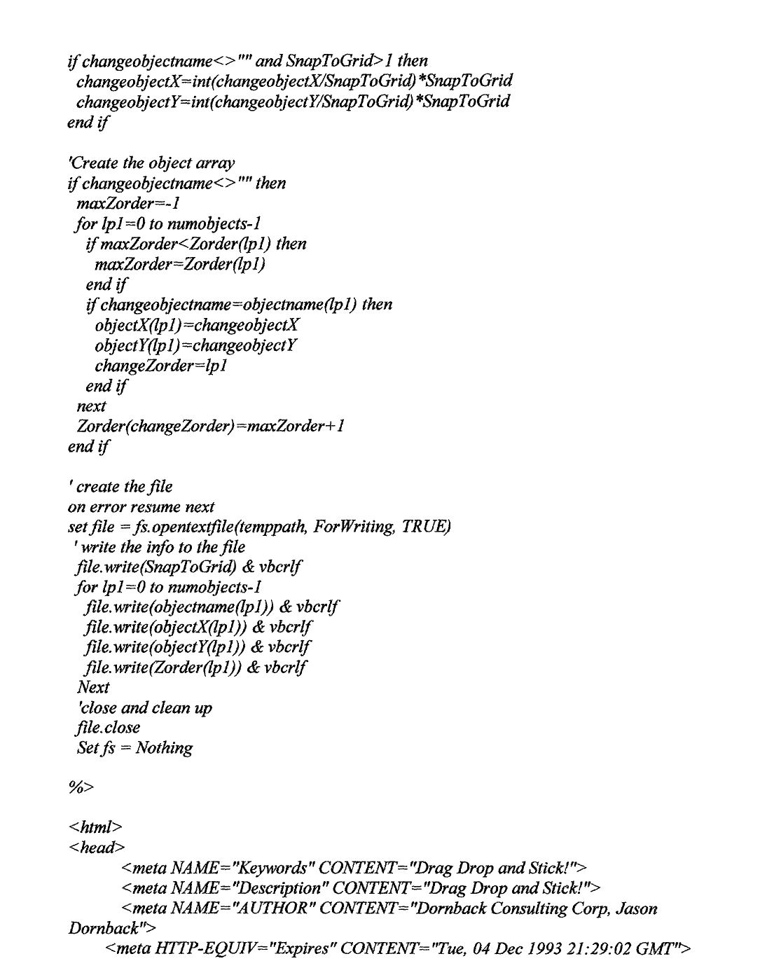

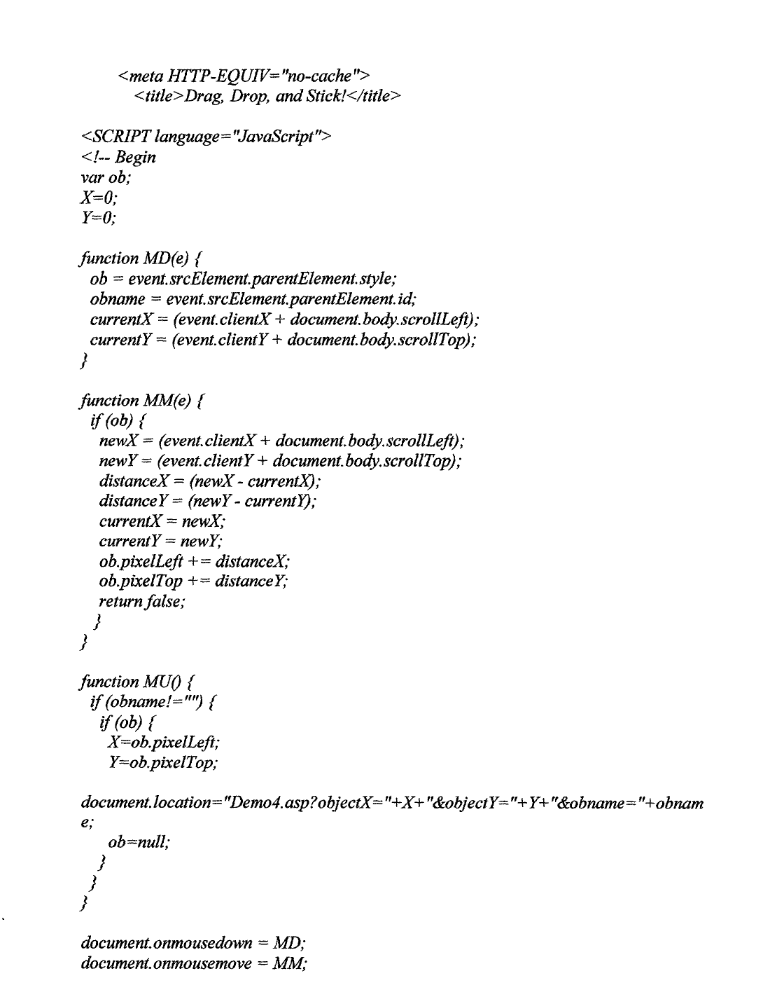

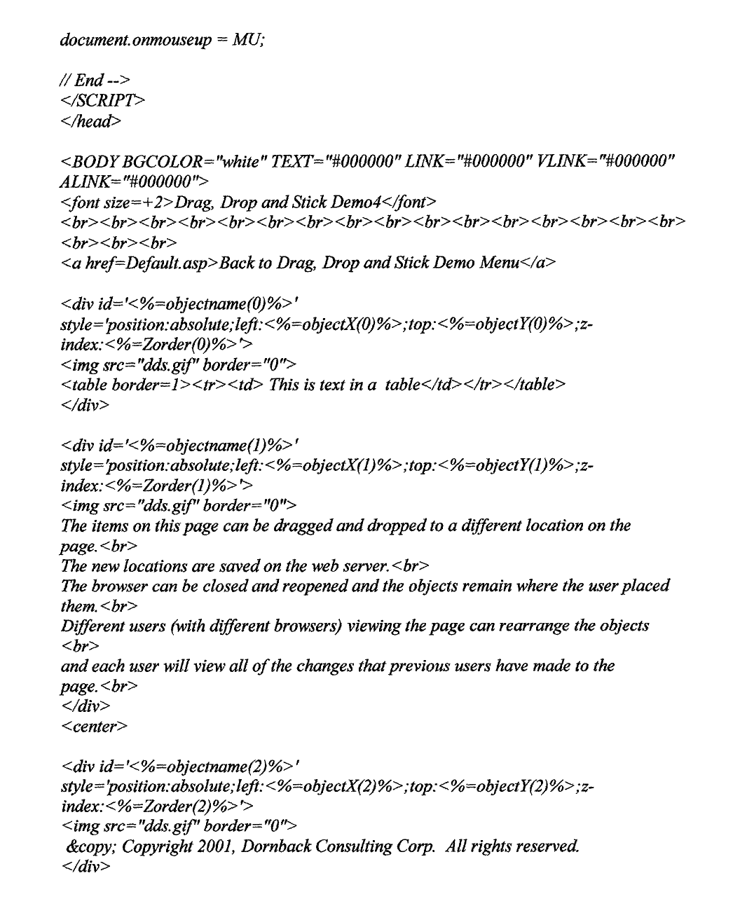

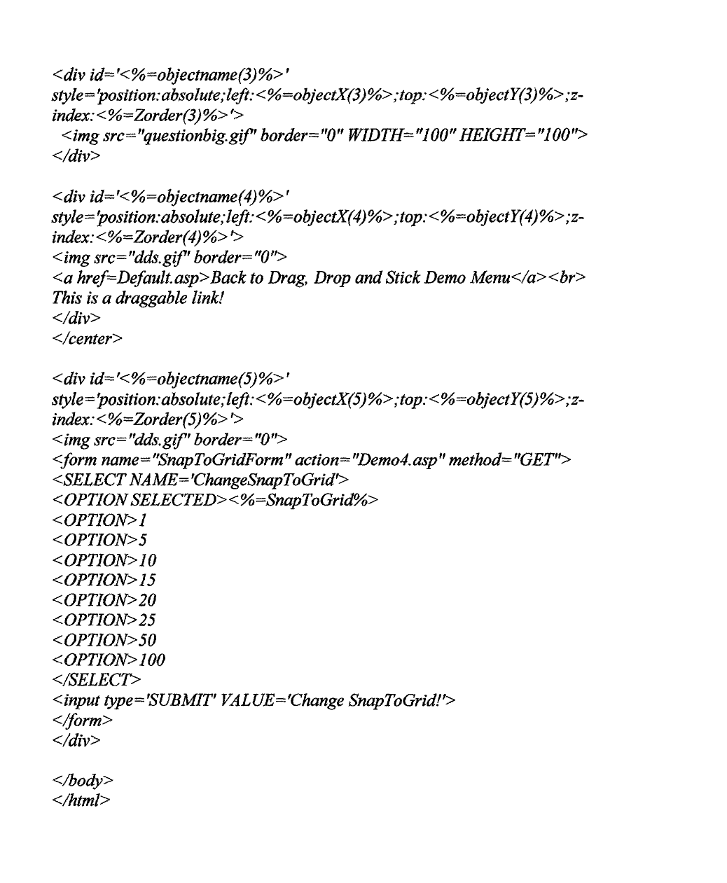

FIG. 12 shows the entire Demo4.asp sample code file. This sample code file is a combination of Active Server Pages, HTML, and javascript. This code demonstrates a variety of this inventions functionality:

Dragging and dropping of text objects.

Dragging and dropping of image objects.

Dragging and dropping of table objects.

Dragging and dropping of functional hyperlink objects.

Dragging and dropping of functional form objects.

Mixing of draggable and non-draggable objects on a page.

User-updateable Snap-To-Grid.

Z-Order updates so the last dropped object is always on top of other objects.

Saving the objects location and z-order in a server-side file.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. It is therefore intended that the following appended claims be interpreted as including all such alterations, permutations, and equivalents as fail within the spirit and scope of the present invention.

What is claimed is:

1. A method for enabling a user to customize the view of a web page by dragging and dropping multiple defined objects on the web page to a new location within the web page.

2. The method of claim 1, further comprising the user dragging the object with the mouse by locating the mouse over the object, holding down the mouse button on the object and moving the mouse.

3. The method of claim 1, further comprising the user dropping the object in a new location on the web page.

4. The method of claim 1, further comprising the objects that can be dragged are collections of HTML tags, including but not limited to:
(a) HTML Formatted text
(b) Images
(c) Hyperlinks
(d) Forms
(e) Tables

5. The method of claim 1, further comprising the functionality of HTML tags within the draggable components on the web page are not affected by the ability to move the objects.

6. The method of claim 1, further comprising the web page may include non-draggable HTML, in addition to draggable objects.

7. The method of claim 6, further comprising the functionality of non-draggable HTML tags on the web page are not affected by the ability to move the objects.

8. A method of saving the new location of each of the multiple objects which determines if the changes to the location of the objects will remain for the current user when the web page is reloaded, and whether the changes will be viewed by other users.

9. The method of claim 8, further comprising:
(a) The new location of the objects is displayed only to the current user.
(b) Other users that view the page from other web browsers will see the objects displayed in the original location, and each user may move the objects on the page independently of other users.
(c) The new location of each of the objects is saved only for the duration that the web page remains open and the web page is not refreshed or reloaded.

10. The method of claim 8, further comprising:
(a) The new location of the objects is saved only for the current user.
(b) The location of the objects is saved independently for each user viewing the page with different web browsers.
(c) Other users that view the page will initially see the objects displayed in the original location, and each user may move the objects on the page independently of other users.
(d) The new location of the objects is saved for each user, even if the web browser is closed, or the web page is refreshed or reloaded.

11. The method of claim 8, further comprising:
(a) The new location of the objects is saved for all users that view the web page.
(b) All users that open the page after the objects are moved will view the objects in the new locations.

12. The method of defining which object is displayed on top if multiple objects overlap on the web page.

13. A method for aligning dropped objects on a snap-to-grid.

14. The method of claim 13, further comprising the ability to define the distance between the spaces of the grid.
